(19) United States
(12) Patent Application Publication
(10) Pub. No.: US 2017/0103446 A1
(43) Pub. Date: Apr. 13, 2017

(54) APPARATUS AND METHOD FOR FORMING PURCHASE AGREEMENTS

(71) Applicant: Wal-Mart Stores, Inc., Bentonville, AR (US)

(72) Inventors: Ruth A. Blass, Bentonville, AR (US); Kellie D. Embree, Bentonville, AR (US); Meriah D. Montondo, Rogers, AR (US)

(21) Appl. No.: 15/286,058

(22) Filed: Oct. 5, 2016

Related U.S. Application Data
(60) Provisional application No. 62/239,557, filed on Oct. 9, 2015.

(51) Int. Cl. G06Q 30/06

(52) U.S. Cl. CPC G06Q 30/0635

(57) ABSTRACT

Systems, apparatuses, and methods are provided herein for forming a purchase agreement. A computer implemented method of forming a purchase agreement comprises: receiving, via a user interface and from the customer, a selection of one or more items to add to a purchase agreement option, calculating, with a control circuit, a total payment amount for the purchase agreement option comprising at least a purchase agreement service fee and a sum of prices of the one or more items according to an inventory database, providing total payment amount and a purchase agreement option expiration date to the customer. A purchase agreement contract based on the purchase agreement option is formed if a first payment for the purchase agreement option is received by the purchase agreement option expiration date. Otherwise, the purchase agreement option is terminated without charging the purchase agreement service fee to the customer.

### CROSS-REFERENCE TO RELATED APPLICATIONS

This application claims the benefit of U.S. Provisional Application No. 62/239,557, filed Oct. 9, 2015, which is incorporated herein by reference in its entirety.

### TECHNICAL FIELD

This invention relates generally to online stores.

### BACKGROUND

Some conventional brick and mortar stores offer installment payment options for customer purchases. To utilize such program, a customer has to go to the store, choose items that qualify for the program, stand in line to put those items on hold, go to the store to make multiple payments, and return to the store to pick up the items. If the items are a gift for someone else, the customer then has to box the items, ship the packages and then track those packages to ensure they are shipped to the intended recipient. Other types of installment payment options may require the customer to open a line of credit, such as a credit card, in order to purchase the items.

### BRIEF DESCRIPTION OF THE DRAWINGS

Disclosed herein are embodiments of apparatuses and methods for forming a purchase agreement. This description includes drawings, wherein:

FIG. 1 is a block diagram of a system in accordance with several embodiments.

FIG. 2 is a flow diagram of a method in accordance with several embodiments.

FIG. 3 is a components diagram of a general process in accordance with several embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein for forming purchase agreements. A system for forming a purchase agreement comprises a purchase agreement contract database, a purchase agreement option database, an inventory database, a communication device for communicating with an ordering system and a plurality of in-store point of sale systems, and a control circuit coupled to the purchase agreement contract database, the purchase agreement option database, the inventory database, and the communication device. The control circuit being configured to: provide a user interface for selecting one or more items for purchase via the communication device, receive, via the user interface and from a customer, a selection of one or more items to add to a purchase agreement option, calculate a total payment amount for the purchase agreement option comprising at least a purchase agreement service fee and a sum of prices of the one or more items based on pricing information in the inventory database, generate a purchase agreement option unique identifier and determine a purchase agreement option expiration date, store the purchase agreement option unique identifier, the total payment amount, and the purchase agreement option expiration date in the purchase agreement option database, and provide the total payment amount and the purchase agreement option expiration date to the customer via the user interface, in an event that a first payment associated with the purchase agreement option is received by the purchase agreement option expiration date, form a purchase agreement contract based on the purchase agreement option and store information associated with the purchase agreement contract in the purchase agreement contract database, and in an event that the first payment not is received by the purchase agreement option expiration date, terminate the purchase agreement option without charging the purchase agreement service fee to the customer.

A system described herein generally allows a customer to choose items on an online shopping user interface such as a website, choose a purchase agreement option at checkout, and be given the ability to enter into the purchase agreement by making payments online using a bank card and/or in person at the store. All fees and sales tax may be calculated and specified and shown to the customer up front so there are no hidden fees or additional money at the end. If the customer uses a bank card and/or a bank account for payment, they may also set up recurring payments for the purchase agreement.

The purchase agreement option may include terms and limitations that are presented to the customer through the user interface. For example, customers may not be permitted to change the items in the purchase agreement once a purchase agreement contract is entered into. The purchase agreement service may include a service fee in addition to the cost of the items. A cancellation fee may be applied if the customer decides to cancel the purchase agreement. The terms may also specify return restrictions for items purchased through installment purchase agreements (e.g. In store return only, within 30 days, service fee non-refundable). The system may permit a customer to simultaneously have multiple purchase agreements and purchase agreement options that can be opened and closed independently of each other. The system may permit the customer to add and/or change shipping addresses for the items. In some cases, additional shipping may be added to the overall total based on shipping address changes.

With the system described wherein, items on a customer's online purchase agreement contract and purchase agreement option may not need to be held in a store or even a warehouse operated by the seller. Instead, items that have not been paid in full may be placed on a hold status either at the distribution center and/or with the upstream distributor/manufacturer. An ordering system may order the item from a supplier to a distribution center when the item is ready to be shipped. Once the items have been purchased, they may be shipped out from the distribution center. If a customer decides not to complete the purchase agreement (e.g. Not paying the full payment amount by the agreement end date), their money may be returned via gift card and/or applied back to their bank card. A service may be charged if the agreement is entered into but not completed.

With the system described herein, a customer would not have to be pre-approved for a retailer bank card to participate in an installment payment service for online purchases. The customer may choose to make payments in person at the store and/or online. The customer also may choose to ship items in a single purchase agreement to multiple addresses.

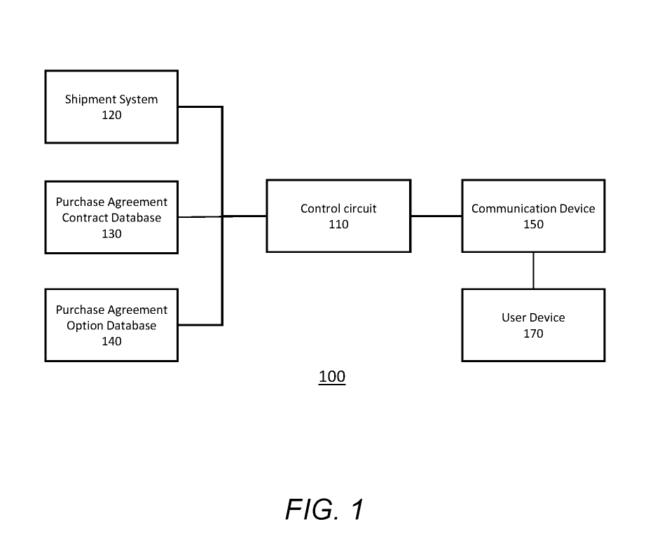

Referring now to FIG. 1, a system for forming a purchase agreement is shown. The system 100 includes a control circuit 110 coupled to an inventory database 120, a purchase agreement contract database 130, a purchase agreement option database 140, and a communication device 150 for communicating with multiple user devices represented by user device 170.

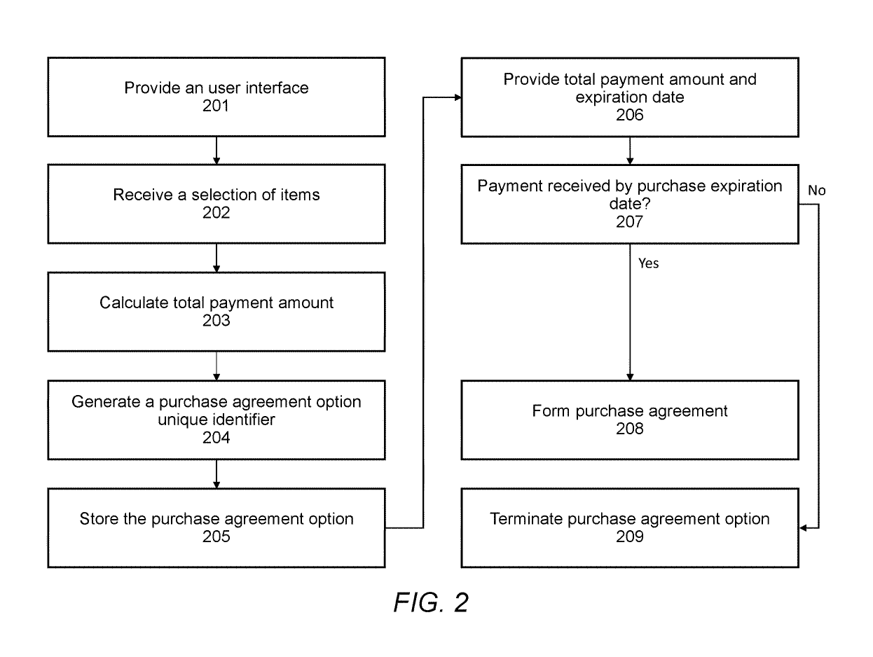

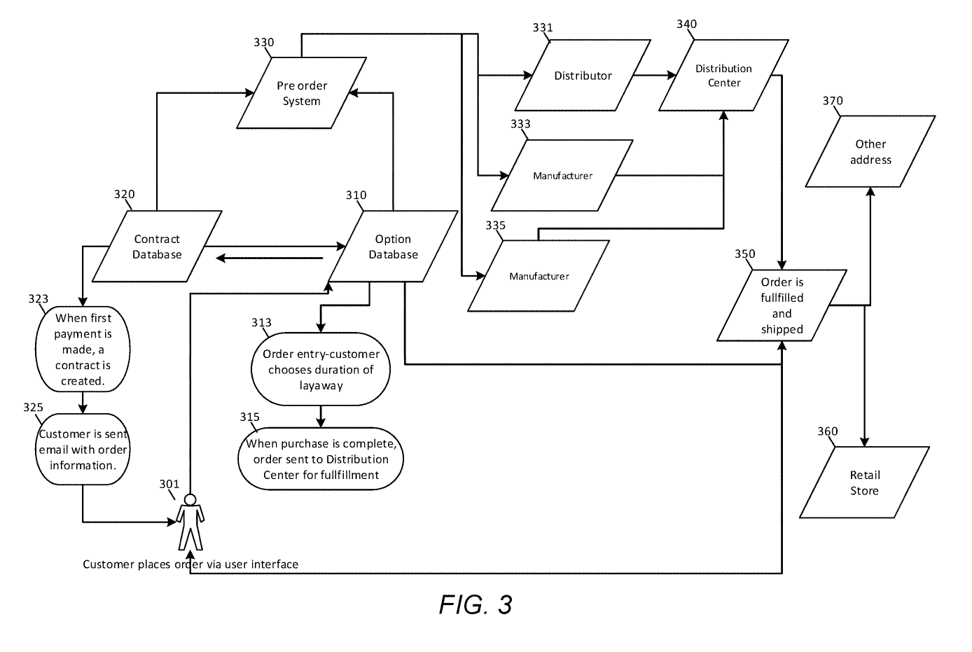

The control circuit 110 may comprise a central processing unit, a processor, a microprocessor, and the like and may be part of a server, a central computing system, a cloud server, and the like. The control circuit 110 may be configured to execute computer readable instructions stored on a computer readable storage memory (not shown). The computer readable storage memory may comprise volatile and/or non-volatile memory and have stored upon it a set of computer readable instructions which, when executed by the control circuit 110, causes the system to provide a user interface to the user device 170 via the communication device 150 and update the information in the purchase agreement contract database 130, the purchase agreement option database 140, and/or the inventory database 120 based at least in part on the communication with the user device 170. Generally, the computer readable instructions may cause the control circuit 110 to perform one or more steps in the methods and processes described with reference to FIGS. 2-3 herein.

The communication device 150 may comprise a wired and/or wireless communication device such as one or more of a network adapter, an internet modem, a local network adapter, a data I/O port, a wi-fi adapter, and the like. Generally, the communication device 150 is configured to communicate with the user device 170 via a network such as the Internet. The control circuit 110 may provide a user interface via a website, a cloud based service, a software program, a program plug-in, a downloaded mobile application (“app”), and the like to the user device 170 through the communication device. The communication device 150 may be configured to receive user input from the user device 170 via the user interface and relay the user input back to the control circuit 110.

The user device 170 may be any processor-based device configured to provide a user interface to, and receive input from, a user. The user device 170 may comprise one or more of a personal computer, a tablet, a mobile device, a smart phone, a wearable device, etc. In some embodiments, the user device 170 may include a web browser for accessing a website user interface provided by the control circuit 110 and/or a shopping program or mobile app for accessing the system 100.

The purchase agreement option database 140 comprises computer readable memory and has stored upon it data associated with a plurality of purchase agreement options. Each purchase agreement option in the purchase agreement option database 140 may include information such as a purchase agreement option unique identifier, a user identifier, one or more items selected by the user, a total price for the selected items, a service fee, and an expiration date for the option. In some embodiments, a purchase agreement option may include other information such as a minimum first payment amount, prices for each of the items selected, one or more shipping addresses, user's preferred physical store, discount codes applied to the order, etc.

The purchase agreement contract database 130 comprises computer readable memory and has stored upon it data associated with a plurality of purchase agreement contracts. Each purchase agreement option in the purchase agreement option database 140 may include information such as a purchase agreement contract identifier, a user identifier, one or more items selected by the user, a total price for the selected items, a service fee, and total payment to date. The total payment to date information may be updated each time the customer submits a payment for the purchase agreement contract. In some embodiments, a purchase agreement may include other information such as prices for each of the items selected, a payment history for the purchase agreement contract, one or more shipping addresses, user's preferred physical store, discount codes applied to the order, etc. In some embodiments, the purchase agreement contract database 130 stores only purchase agreement contracts formed by the system 100. In some embodiments, the purchase agreement contract database 130 may also store and be used to manage installment purchase agreements formed through other means, such as through in-store installment purchase agreement services. In some embodiments, the purchase agreement contract database 130 and the purchase agreement options database 140 may be implemented as one database. For example, each database entry may be marked as either being a purchase agreement option or a purchase agreement contract.

The inventory database 120 has stored upon it availability and pricing information for a plurality of items for purchase. In some embodiments, the inventory database 120 may include all items offered for sale in a retail company's brick and mortar and/or online store, whether the item is currently in-stock in the retail company's physical inventory. The inventory database 120 may further include item categorization, restrictions, expirations, and discounts information for one or more items in the database. In some embodiments, the inventory database 120 may be shared with one or more of online stores, physical stores, warehouses, and distribution center inventory systems. Generally, the information in the inventory database 120 may be used by the control circuit 110 and/or another online store system to determine what items should be displayed in the online shopping user interface. The pricing information in the inventory database 120 may further be used by the control circuit 110 to determine a total payment amount for purchase agreements generated and/or modified by the control circuit 110.

In some embodiments, one or more of the inventory database 120, the purchase agreement contract database 130, the purchase agreement option database 140, and the memory device coupled to the control circuit 110 may be implemented on the same one or more memory devices or implemented on two or more separate devices. The inventory database 120, the purchase agreement contract database 130, the purchase agreement option database 140, and the memory device coupled to the control circuit 110 may comprise local, remote, networked, and/or cloud based storage accessible by the control circuit 110. In some embodiments, one or more of the inventory database 120, the purchase agreement contract database 130, the purchase agreement option database 140, the control circuit 110, and the communication device 150 may be implemented on the same one or more physical devices or on two or more separate devices. For example, the control circuit 110, the communication device 150, and the purchase agreement option database 140 may be implemented on an online store server while the inventory database 120 and the purchase agreement contract database 130 may be separately implemented databases accessible by multiple systems.

In some embodiments, the system 100 may further include a preorder system. The preorder system may gather information from one or more of the purchase agreement contract database 130 and the purchase agreement option database 140 to predict future inventory requirements. For example, the preorder system may determine that one or more items are in high demand based on the items selected in the purchase agreement options and/or purchase agreement contracts. During holiday seasons, for instance, the items in the purchase agreements may be used to predict popular gift items for the season. The preorder system may then increase the item count or the ordering frequency for the next purchase order to the manufacturer and/or distributor. In another example, the preorder system may anticipate the completion of a purchase agreement contract (e.g. payment nearly complete, gift giving holiday approaches, customer has a good contract completion track history) and arrange for items in the purchase agreement contracts to be ordered, reserved, and/or transferred to distribution centers associated with one or more shipping addresses and/or stores prior to receiving the final payment for the purchase agreement contract.

In some embodiments, the system 100 may further include one or more in-store computer systems. The in-store computer system may be a point of sales system, a customer service terminal, a purchase agreement service kiosk, and the like. The in-store computer system may allow a user to retrieve information about their purchase agreement contracts and/or options and submit payments for their purchase agreement contract with or without the assistance of a store clerk. In some embodiments, the user may also modify details of the purchase agreement contract and/or option via the in-store computer system. For example, a customer may modify shipping options (e.g. ship to address or ship to store for pick up), modify shipping addresses, and/or request a price match via the in-store computer system. In some embodiments, the in-store computer system may be configured to accept payment through one or more of credit card, debit card, gift card, cash, and check with or without store clerk assistance.

Referring now to FIG. 2, a method of forming a purchase agreement is shown. In some embodiments, the steps shown in FIG. 2 may be performed by a processor-based device as such the control circuit 110 executing a set of computer readable instructions.

In step 201, the system provides a user interface for selecting one or more items for purchase. The user interface may include or be part of an online shopping user interface such as a webstore. In some embodiments, the user interface is provided via a website accessible by a general web browser. In some embodiments, the user interface may be part of a downloaded and/or cloud based program such as a mobile application. The items for purchase in the user interface may be listed based on the availability and/or pricing information in an inventory database. In some embodiments, items in the inventory database may be marked as being eligible or ineligible for purchase agreements. For example, items that are on clearance or are about to be discontinued may not be eligible for purchase through the purchase agreement option. In some embodiments, the user interface may provide other navigation features such as categorization and/or provide search functions.

In step 202, the system receives a selection of one or more items to add to a purchase agreement option. In some embodiments, the user interface may provide a virtual basket or cart for the user to build a list of item for purchase as they navigate through the store. In some embodiments, the customer may choose to add an item to a purchase agreement option program or an up-front purchase when the item is added to the basket/cart. In some embodiments, the customer may be offered the choice of paying for items in full or use the purchase agreement option during the checkout process. In some embodiments, the customer may select which items in the virtual cart/basket the customer wishes to pay for right away and which items should be added to the purchase agreement option on a view cart/basket screen. In some embodiments, if a virtual basket/cart contains items that are not eligible for the purchase agreement and the customer selects the purchase agreement option at checkout, the system may notify the customer. In some embodiments, the purchase agreement online shopping interface may be separate from the regular online shopping interface. For example, a service agreement option shopping user interface may only display items that are eligible for the purchase agreement program and only allow for purchase via purchase agreement options.

In step 203, the system calculates a total payment amount for the purchase agreement. The total payment amount may include an installment purchase service fee and a sum of prices of all items selected by the customer in step 202. In some embodiments, the total payment amount may include other applicable fees such as shipping and handling charges, local, state, and federal taxes, etc. In some embodiments, the shipping charge may be waived based on the sum of the prices of all items and/or other promotional offers (e.g. free shipping over $50in purchase). Generally, the total payment amount calculated in step 203 is the total amount that a customer needs to render to the seller to complete the purchase agreement and have the items shipped to the customer. In some embodiments, the total payment amount may be calculated and displayed to the user as the user select items to add to a purchase list in step 202.

In step 204, the system generates a purchase agreement option unique identifier and determines a purchase agreement option expiration date. The purchase agreement option unique identifier may be any computer readable value that can be used to identify and retrieve the purchase agreement option by the system and/or the customer. The purchase agreement option expiration date corresponds to the date by which the first payment must be received before the purchase agreement option is terminated. In some embodiments, the customer may select a purchase agreement option expiration date. In some embodiments, the system may set the purchase agreement option expiration date to be a predefined number of days from the day that one or more of steps 202 and 204 are performed (e.g. two weeks, one month). In some embodiments, the purchase agreement option expiration date may be determined based on one or more of the total payment amount, customer purchase history, and time of the year. For example, a shortened purchase agreement option period may be given during holiday seasons as compared to the rest of the year (e.g. 2 weeks instead of 1 month). In some embodiments, the system may further determine and provide a purchase agreement contract end date, which corresponds to the date that the final payment must be received once a purchase agreement contract is formed. If the customer submits a first payment by the purchase agreement option expiration date to form the purchase agreement contract, but does not submit the total payment amount by the purchase agreement contract end date, the store may return the payment amount, minus the service and/or cancellation fee, to the customer to end the purchase agreement contract. In some embodiments, the purchase agreement contract end date may be determined when the first payment is submitted,

In step 205, the system stores the purchase agreement option unique identifier, the total payment amount, and the purchase agreement option expiration date in a purchase agreement option database. In some embodiments, a purchase agreement option may include other information such as minimum first payment amount, prices for each of the items selected, one or more shipping addresses, user's preferred physical store, discount codes applied to the order, etc. In some embodiments, a user may specify different shipping addresses for items in a purchase agreement option.

In step 206, the system provides the total payment amount and the purchase agreement option expiration date to the customer via the user interface. In some embodiments, step 206 may occur prior to or concurrently with steps 202, 204, and/or 205. In some embodiments, other terms and details of the purchase agreement may also be displayed to the customer. For example, the customer may be notified of the minimal amount due for the first payment, a purchase agreement contract end date, accepted method of payment (e.g. In-store with cash, online with credit card, etc.), return policy, available shipment options, purchase agreement service and/or cancellation fees, etc. In some embodiments, after step 206, the customer may confirm or cancel the purchase agreement option. If the customer cancels the purchase agreement option, the purchase agreement along with the unique identifier may be removed from the purchase agreement option database and/or be placed on a canceled status. In some embodiments, in step 206, the system may send out a confirmation information (e.g. via email) including the purchase agreement option identifier, total payment amount, and expiration to the user. In some embodiments, after step 206 the system may allow the customer to log-in and view the purchase agreement option and/or submit the first payment. In some embodiments, the system may allow the customer to modify the purchase agreement option after 206. For example, the customer may be able to add to remove an item and/or add or remove a shipping address. In some embodiments, when a customer modifies a purchase agreement option, the system may generate a new total payment price and/or a purchase agreement option expiration date. The system may allow the customer to specify different shipping addresses for items in one purchase agreement. The system may also offer in-store pickup options for items in the purchase agreement.

In step 207, the system determines whether a first payment is received on or before the purchase agreement expiration date. The customer may make the first payment by entering payment information through the online user interface. In some embodiments, the user may enter credit card, debit card, and/or online payment service information (e.g. PayPal, Google wallet). The customer may also set up recurring payments from bank cards and payment service accounts either instore or online. In some embodiments, the payment information may be previously stored in the system and in step 207, the customer may authorize an amount to be charged for the first payment. In some embodiments, the customer may go to a brick and mortar store and/or an authorized payment acceptance agent to make payments through a point of sales system, customer service counter, and/or a purchase agreement service kiosk. For example, the customer may swipe a credit or debit card or render cash or check to a cashier, a customer service agent, and/or a kiosk to make the first payment. The store clerk may retrieve the purchase agreement option using the customer's purchase agreement option unique identifier and submit the first payment made in the store to the online system. In some embodiments, the customer may specify the amount of the first payment. In some embodiments, the system may set a minimum first payment amount and determine whether the minimum first payment amount is met in step 206 based on whether the first payment exceeds the minimum payment. For example, the minimum first payment amount may be equal or greater than the service fee for using the purchase agreement service.

If a first payment is received for the purchase agreement option in step 207, in step 208, a purchase agreement contract is formed and stored into a purchase agreement contract database. The purchase agreement contract may be converted from and include information in the original purchase agreement option. The purchase agreement contract may include a user identifier, one or more items selected by the user, a total price for the selected items, a service fee, and remaining payment amount. In some embodiments, a purchase agreement may include other information such as prices for each of the items selected, payment history, purchase agreement contract expiration date, one or more shipping addresses, user's preferred physical store, discount codes applied to the order, etc. Generally, the first payment may be lesser than the total payment amount for the purchase agreement option. In some embodiments, a customer may convert items in a purchase agreement option into a regular purchase list and pay for the items in full without paying the service fee. In some embodiments, the customer may request a price match for the current pricing just prior to submitting the first payment.

After a purchase agreement is formed by the customer making the first payment, the system may process purchase agreement payments of any amount from the customer, up to the total payment amount, any time prior to an expiration of the purchase agreement. For example, the customer may make a $20 first payment, a $40 payment a week later, a $15 final payment two weeks after to complete a purchase agreement contract with a total payment amount of $75. The subsequent payments may be made via similar methods for submitting the first payment. For example, the customer may use an online payment method or make payments in-store. The system may then update a remaining amount due associated with the purchase agreement in the purchase agreement contract database based on a processed purchase agreement payment. Generally, the remaining amount may be reduced by the payment amount each time the customer submits a payment. When the remaining amount reaches zero, the purchase agreement is considered to be completed by the customer.

The system may further determine whether the total payment amount is received by a purchase agreement contract end date. If the total payment amount is received prior to the purchase agreement contract end date, the system then forwards the order to an order fulfillment and shipment system which will ship the items in the purchase agreement contract to one or more addresses specified by the user. In some embodiments, the user may specify one or more items for store pickup. In some embodiments, the user may schedule a final payment date via the user interface and schedule in-store pickup for the same day. In some embodiments, the user may initiate the shipment of the items in the purchase agreement by making the full payment for the purchase agreement prior to the purchase agreement contract end day.

If the total payment amount is not received by the purchase agreement contract end date and/or the customer wishes to cancel the purchase agreement contract after the first payment is made, the customer may be entitled to a refund of the purchase agreement payment. In some embodiments, the customer may be refunded the money paid to date, minus any service agreement service fee and/or cancellation fee. The refund may be issued in the form of store credit and/or in the original form of payment.

If a first payment is not received by the purchase agreement option expiration date in step 207, in step 209, a purchase agreement option is terminated without charging the purchase agreement service fee to the customer. The purchase agreement option described herein offers customers a way to configure and save purchase agreements online without upfront financial commitment. Customers without access to online payment methods (credit cards, bank cards) can also use this service to configure a purchase agreement online and make payments in-store. In some embodiments, prior to step 209, the system may send a notification to the customer a few days prior to the purchase agreement contract expiration date. In some embodiments, a terminated purchase agreement option may be removed from the purchase agreement options database. In some embodiments, a terminated purchase agreement option may be used to determine customer preferences for future targeted promotions.

In some embodiments, the system may permit price adjustments after step 206 and/or step 208. The purchase agreement option and/or the purchase agreement contract may include pricing information for each item at the time the purchase agreement option is received. In some embodiments, the system may generate an automatic notification when there is a price drop. The customer may be offered the option to price match the items in the purchase agreement option and/or the purchase agreement contract to the current price of the item. In some embodiments, the system may allow for price adjustment for purchase agreement options but not purchase agreement contracts. In some embodiments, the system may calculate a new total amount due and/or determine a new expiration date when a price adjustment is performed. In some embodiments, the system may suggest alternate items for items in a purchase agreement option to lower the total payment amount.

In some embodiment, a preorder system may use the purchase agreement options generated in steps 204 and purchase agreement contracts formed in step 208 to generate and modify purchase orders to suppliers, distributors, and/or manufacturers. For example, the preorder system may determine one or more items that are in high demand based on the items selected in the purchase agreement options and/or purchase agreement contracts. The preorder system may then increase the item count and/or ordering frequency for the next purchase order from the supplier. Generally, the information in the purchase agreement option database and the purchase agreement contract may be used to forecast future inventory demands. In some embodiments, the preorder system may anticipate the completion of a purchase agreement contract (e.g. payment nearly complete, gift giving holiday approaches, customer's contract completion track history) and arrange for items in the purchase agreement contracts to be ordered, reserved, and/or transferred to distribution centers associated with one or more shipping addresses so that they are ready to ship when the final payment is received. In some embodiments, at least some items may not be ordered from the manufacturer/distributor and/or reserved in the inventory until a purchase agreement is paid in full or nearly paid in full.

Referring now to FIG. 3, a components diagram of a general process for forming and processing purchase agreement contracts is shown. A customer 301 first places an order via a user interface on a user device. The purchase agreement option is submitted to the option database 310. In step 313, during the order entry, the customer may choose a duration of the purchase agreement option to set the purchase agreement option expiration date. In some embodiments, the purchase agreement option expiration date may be determined by the system. In step 315, when the purchase is completed, the associated order is sent to a distribution center for fulfillment based on the purchase agreement option and/or purchase agreement contract in the contract database 320.

If the customer enters into a purchase agreement contract by making a first payment, the option database 310 forwards the purchase agreement option to the contract database 320. When a first payment is made, a purchase agreement contract is created from a purchase agreement option in step 323. In step 325, the customer is sent an email with order information for the purchase agreement.

The preorder system 330 may use the information in the contract database 320 and/or the option database 310 to generate and/or modify purchase orders. For example, the preorder system may determine when and how much of each item to order. Orders generated by the preorder system 330 are sent to distributor 311 and/or manufacturers 333 and 335. The distributor 311 and/or manufacturers 333 and 335 fill the retailer order by sending the ordered items to distribution center 340. In some embodiments, a retailer may use two or more distribution centers and the preorder system may specify a distribution center for ordered items based on information in the contract database 320 and/or option database 310. Once the item arrives at the distribution center 340 and the full payment for the purchase is received in step 350, the order is fulfilled and shipped. Based on the customer's selection in the purchase agreement, the item may be shipped to one or more retail stores 360 and/or one or more other addresses 370 such as commercial and/or residential addresses.

With the methods, systems, and apparatuses described herein, customers may use an online shopping user interface to configure and create purchase agreements that allow for flexible installment payments. Generally, the customers may be given a period of time prior to financially committing to the purchase agreement option by making the first payment either online or in store. Once a purchase agreement contract is created, the customer may make payments in any amount and at any time prior to the purchase agreement contract to pay for items they selected. The retailer may hold items in purchase agreements either with the supplier, at a distribution center, or at a central warehouse without taking up space at store locations. The purchase agreement service provides convenience and flexibility to customers who wishes to use installment payment services for making purchases. The service also provides valuable data to the retailers for inventory management and demand prediction.

In one embodiment, a system for forming a purchase agreement comprises a purchase agreement contract database, a purchase agreement option database, an inventory database, a communication device for communicating with a ordering system and a plurality of in-store point of sale systems, and a control circuit coupled to the purchase agreement contract database, the purchase agreement option database, the inventory database, and the communication device. The control circuit being configured to: provide a user interface for selecting one or more items for purchase via the communication device, receive, via the user interface and from a customer, a selection of one or more items to add to a purchase agreement option, calculate a total payment amount for the purchase agreement option comprising at least a purchase agreement service fee and a sum of prices of the one or more items based on pricing information the inventory database, generate a purchase agreement option unique identifier and determine a purchase agreement option expiration date, store the purchase agreement option unique identifier, the total payment amount, and the purchase agreement option expiration date in the purchase agreement option database, and provide the total payment amount and the purchase agreement option expiration date to the customer via the user interface, in an event that a first payment associated with the purchase agreement option is received by the purchase agreement option expiration date, form a purchase agreement contract based on the purchase agreement option and store information associated with the purchase agreement contract in the purchase agreement contract database, and in an event that the first payment not is received by the purchase agreement option expiration date, terminate the purchase agreement option without charging the purchase agreement service fee to the customer.

In one embodiment, a computer implemented method of forming a purchase agreement comprises: providing an user interface to a customer via a communication device, receiving, via the user interface and from the customer, a selection of one or more items to add to a purchase agreement option, calculating, with a control circuit, a total payment amount for the purchase agreement option comprising at least a purchase agreement service fee and a sum of prices of the one or more items according to an inventory database, generating a purchase agreement option unique identifier and determine a purchase agreement option expiration date, storing the purchase agreement option unique identifier, the total payment amount, and the purchase agreement option expiration date in a purchase agreement option database, and providing, via the user interface, the total payment amount and the purchase agreement option expiration date to the customer, in an event that a first payment for the purchase agreement option is received by the purchase agreement option expiration date, forming a purchase agreement contract based on the purchase agreement option and storing information associated with the purchase agreement in a purchase agreement database, and in an event that the first payment not is received by the purchase agreement option expiration date, terminating the purchase agreement option without charging the purchase agreement service fee to the customer.

In one embodiment, an apparatus for providing a dynamic shopping interface comprising: a non-transitory storage medium storing a set of computer readable instructions, and a control circuit configured to execute the set of computer readable instructions which causes to the control circuit to: provide a user interface to a customer for selecting items for purchase via a communication device, receive, via the user interface and from the customer, a selection of one or more items to add to a purchase agreement option, calculate a total payment amount for the purchase agreement option comprising at least a purchase agreement service fee and a sum of prices of the one or more items based on pricing information an inventory database, generate a purchase agreement option unique identifier and determine a purchase agreement option expiration date, store the purchase agreement option unique identifier, the total payment amount, and the purchase agreement option expiration date in a purchase agreement option database, and provide the total payment amount and the purchase agreement option expiration date to the customer via the user interface, in an event that a first payment associated with the purchase agreement option is received by the purchase agreement option expiration date, form a purchase agreement based on the purchase agreement option and store information associated with the purchase agreement in a purchase agreement contract database, and in an event that the first payment not is received by the purchase agreement option expiration date, terminate the purchase agreement option without charging the purchase agreement service fee to the customer.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for forming a purchase agreement, comprising:
a purchase agreement contract database;
a purchase agreement option database;
an inventory database;
a communication device for communicating with an ordering system and a plurality of in-store point of sale systems; and
a control circuit coupled to the purchase agreement contract database, the purchase agreement option database, the inventory database, and the communication device and configured to:
provide a user interface for selecting one or more items for purchase via the communication device;
receive, via the user interface and from a customer, a selection of one or more items to add to a purchase agreement option;
calculate a total payment amount for the purchase agreement option comprising at least a purchase agreement service fee and a sum of prices of the one or more items based on pricing information the inventory database;
generate a purchase agreement option unique identifier and determine a purchase agreement option expiration date;
store the purchase agreement option unique identifier, the total payment amount, and the purchase agreement option expiration date in the purchase agreement option database; and
provide the total payment amount and the purchase agreement option expiration date to the customer via the user interface;
in an event that a first payment associated with the purchase agreement option is received by the purchase agreement option expiration date, form a purchase agreement contract based on the purchase agreement option and store information associated with the purchase agreement contract in the purchase agreement contract database; and
in an event that the first payment not is received by the purchase agreement option expiration date, terminate the purchase agreement option without charging the purchase agreement service fee to the customer.

2. The system of claim 1, wherein the control circuit is further configured to:
process, after the purchase agreement contract is formed, a purchase agreement payment of any amount from the customer, up to the total payment amount, any time prior to an end date of the purchase agreement contract ; and
update a remaining amount due associated with the purchase agreement contract in the purchase agreement contract database based on a processed purchase agreement payment.

3. The system of claim 1, wherein the total payment amount further comprises one or more of a sales tax and a shipping charge.

4. The system of claim 1, wherein the control circuit is further configured to receive and store two or more shipment addresses for different items in the purchase agreement option.

5. The system of claim 1, wherein the purchase agreement option stored in the purchase agreement option database comprises prices for each of the one or more items in the purchase agreement option at a time the purchase agreement option is received.

6. The system of claim 5, further comprising:
a preorder system,
wherein the preorder system is configured to automatically place an order to a supplier based on information in the purchase agreement option database.

7. The system of claim 1, wherein the control circuit is further configured to:
provide a notification to the customer when an item in one of the purchase agreement option and the purchase agreement contract has a current price that is lower than a price of the item stored in one of the purchase agreement option and the purchase agreement contract.

8. The system of claim 1, wherein the control circuit is further configured to:
adjust the price of an item in one of the purchase agreement option and the purchase agreement contract to the current price of the item after the purchase agreement option has been placed or the purchase agreement contract has been formed.

9. The system of claim 1, wherein the control circuit is further configured to:
store multiple purchase agreement options in the purchase agreement option database and multiple purchase agreements contacts in the purchase agreement contract database for the same customer.

10. The system of claim 1, wherein the control circuit is configured to:
initiate a shipment of the one or more items specified in the purchase agreement upon a full payment of the total payment amount.

11. A computer implemented method of forming a purchase agreement, comprising:
providing a user interface to a customer via a communication device;
receiving, via the user interface and from the customer, a selection of one or more items to add to a purchase agreement option;
calculating, with a control circuit, a total payment amount for the purchase agreement option comprising at least a purchase agreement service fee and a sum of prices of the one or more items according to an inventory database;
generating a purchase agreement option unique identifier and determine a purchase agreement option expiration date;
storing the purchase agreement option unique identifier, the total payment amount, and the purchase agreement option expiration date in a purchase agreement option database; and
providing, via the user interface, the total payment amount and the purchase agreement option expiration date to the customer;
in an event that a first payment for the purchase agreement option is received by the purchase agreement option expiration date, forming a purchase agreement contract based on the purchase agreement option and storing information associated with the purchase agreement in a purchase agreement database; and
in an event that the first payment not is received by the purchase agreement option expiration date, terminating the purchase agreement option without charging the purchase agreement service fee to the customer.

12. The method of claim 11, further comprising:
processing, after the purchase agreement contract is formed, a purchase agreement payment of any amount from the customer up to the total payment amount any time prior to an end date of the purchase agreement contract; and
updating a remaining amount due associated with the purchase agreement in the purchase agreement database based on a processed purchase agreement payment.

13. The method of claim 11, wherein the total payment amount further comprises one or more of a sales tax and a shipping charge.

14. The method of claim 11, further comprising:
receiving and storing two or more shipment addresses for different items in the purchase agreement option.

15. The method of claim 11, wherein the purchase agreement option stored in the purchase agreement option database comprises prices for each of the one or more items in the purchase agreement option at a time the purchase agreement option is received.

16. The method of claim 15, wherein a preorder system is configured to automatically place an order to a supplier based on information in the purchase agreement option database.

17. The method of claim 11, further comprising:
providing a notification to the customer when an item in one of the purchase agreement option and the purchase agreement contract has a current price that is lower than a price of the item stored in one of the purchase agreement option and the purchase agreement contract.

18. The method of claim 11, further comprising:
adjusting the total payment amount for one of the purchase agreement option and the purchase agreement contract based on the current price of the item.

19. The method of claim 11, further comprising:
storing multiple purchase agreement options in the purchase agreement option database and multiple purchase agreements in the purchase agreement database for the same customer.

20. The method of claim 11, further comprising:
initiating a shipment of the one or more items specified in the purchase agreement contract upon a full payment of the total payment amount.

21. An apparatus for providing a dynamic shopping interface comprising:
a non-transitory storage medium storing a set of computer readable instructions; and
a control circuit configured to execute the set of computer readable instructions which causes to the control circuit to:
provide a user interface to a customer for selecting items for purchase via a communication device;
receive, via the user interface and from the customer, a selection of one or more items to add to a purchase agreement option;
calculate a total payment amount for the purchase agreement option comprising at least a purchase agreement service fee and a sum of prices of the one or more items based on pricing information an inventory database;
generate a purchase agreement option unique identifier and determine a purchase agreement option expiration date;
store the purchase agreement option unique identifier, the total payment amount, and the purchase agreement option expiration date in a purchase agreement option database; and
provide the total payment amount and the purchase agreement option expiration date to the customer via the user interface;
in an event that a first payment associated with the purchase agreement option is received by the purchase agreement option expiration date, form a purchase agreement based on the purchase agreement option and store information associated with the purchase agreement in a purchase agreement contract database; and
in an event that the first payment not is received by the purchase agreement option expiration date, terminate the purchase agreement option without charging the purchase agreement service fee to the customer.
